(19) United States
(12) Patent Application Publication
(10) Pub. No.: US 2022/0245536 A1
(43) Pub. Date: Aug. 4, 2022

(54) METHOD AND DEVICE FOR UPDATING AI MODELS, AND STORAGE MEDIUM

(71) Applicant: BOE Technology Group Co., Ltd., Beijing (CN)

(72) Inventor: Lin FAN, Beijing (CN)

(21) Appl. No.: 17/555,243

(22) Filed: Dec. 17, 2021

(30) Foreign Application Priority Data
Jan. 29, 2021 (CN) 202110128379.4

(51) Int. Cl. G06Q 10/06; H04L 67/55; H04L 67/00

(52) U.S. Cl. CPC G06Q 10/067; H04L 67/34; H04L 67/26

(57) ABSTRACT

Disclosed are a method and device for updating AI models, and a storage medium. The method is applicable to an AI server that includes a model running environment and a model training environment. An AI model deployed in the model running environment is available for a user. The method includes: acquiring business data generated by a target user in a process of using a first AI model, the first AI model being deployed in the model running environment; and updating a second AI model based on the business data, the second AI model being deployed in the model training environment, the second AI model being identical to the first AI model.

### CROSS-REFERENCE TO RELATED APPLICATION

This application is based on and claims priority to Chinese Patent Application No. 202110128379.4, filed on Jan. 29, 2021 and entitled “UPDATE METHOD, UPDATE DEVICE, AI SERVER AND STORAGE MEDIUM FOR AI SERVICE PLATFORM,” the disclosure of which is incorporated herein by reference in its entirety.

### TECHNICAL FIELD

The present disclosure relates to a method and device for updating AI models, and a storage medium.

### BACKGROUND

An artificial intelligence (AI) service platform is a network platform that provides a user with AI model training and AI model publishment. Currently, an AI server of the AI service platform typically generates sample data based on raw data, trains an AI model based on the sample data, and publishes trained the AI model online.

### SUMMARY

Embodiments of the present disclosure provide a method and device for updating AI models, and a storage medium.

According to one aspect of the embodiments of the present disclosure, a method for updating AI models is provided. The method is applicable to an AI server. The AI server includes a model running environment and a model training environment, wherein the AI model deployed in the model running environment is available for a user.

The method includes: acquiring business data generated by a target user in a process of using a first AI model, wherein the first AI model is deployed in the model running environment; and updating a second AI model based on the business data, wherein the second AI model is deployed in the model training environment, and the second AI model is identical to the first AI model.

In some embodiments, prior to acquiring the business data generated by the target user in the process of using the first AI model, the method further includes: deploying the first AI model into the model running environment.

In some embodiments, upon updating the second AI model based on the business data, the method further includes: deploying the updated second AI model into the model running environment, such that the updated second AI model functions in place of the first AI model in the model running environment.

In some embodiments, upon updating the second AI model based on the business data, the method further includes: adjusting model parameters of the first AI model based on model parameters of an updated second AI model.

In some embodiments, prior to acquiring the business data generated by the target user in the process of using the first AI model, the method further includes: pushing a link of the first AI model to a terminal device of the target user who has logged into the AI server, such that the first AI model is available for the target user via the link.

In some embodiments, prior to pushing the link of the first AI model to the terminal device of the target user who has logged into the AI server, the method further includes: receiving a first login request, wherein the first login request includes first user information, and determining, based on the first user information, that a user corresponding to the first login request is the target user; and pushing the link of the first AI model to the terminal device of the target user who has logged into the AI server includes: pushing the link of the first AI model to the terminal device of the target user in the case that the user corresponding to the first login request is the target user.

In some embodiments, prior to pushing the link of the first AI model to the terminal device of the target user who has logged into the AI server, the method further includes: receiving a second login request, wherein the second login request includes second user information, determining, based on the second user information, that a user corresponding to the second login request is an administrative user, and displaying an AI service list including an AI service corresponding to the first AI model in the case that the user corresponding to the second login request is the administrative user; and pushing the link of the first AI model to the terminal device of the target user who has logged into the AI server includes: pushing the link of the first AI model to a terminal device of the target user in response to receiving a push instruction triggered based on the AI service corresponding to the first AI model in the AI service list.

In some embodiments, pushing the link of the first AI model to the terminal device of the target user who has logged into the AI server includes: sending push information to the terminal device of the target user who has logged into the AI server, wherein the push information includes the link of the first AI model.

In some embodiments, the method further includes: displaying an AI service page including the updated second AI.

In some embodiments, updating the second AI model based on the business data includes: determining a plurality of training samples based on the business data; and training the second AI model based on the plurality of training samples until a stop condition is satisfied.

In some embodiments, prior to training the second AI model based on the plurality of training samples, the method further includes: preprocessing the plurality of training samples.

According to a second aspect of the embodiments of the present disclosure, an apparatus for updating AI models is provided. The apparatus is applicable to an AI server. The AI server includes a model running environment and a model training environment, wherein an AI model deployed in the model running environment is available for a user.

The apparatus includes: an acquiring module, configured to acquire business data generated by a target user in a process of using a first AI model, wherein the first AI model is deployed in the model running environment; and an updating module, configured to update a second AI model based on the business data, wherein the second AI model is deployed in the model training environment, and the second AI model is identical to the first AI model.

In some embodiments, the apparatus further includes a first deploying module, configured to deploy the first AI model into the model running environment before the business data generated by the target user in the process of using the first AI model is acquired.

In some embodiments, the apparatus further includes a second deploying module, configured to deploy an updated second AI model into the model running environment after the second AI model is updated based on the business data, such that the updated second AI model functions in place of the first AI model in the model running environment.

In some embodiments, the apparatus further includes an adjusting module, configured to adjust model parameters of the first AI model based on model parameters of the updated second AI model.

In some embodiments, the apparatus further includes a pushing module, configured to push a link of the first AI model to a terminal device of the target user who has logged into the AI server before the business data generated by the target user in the process of using the first AI model is acquired, such that the first AI model is available for the target user via the link.

In some embodiments, the apparatus further includes: a first receiving module, configured to receive a first login request before the link of the first AI model is pushed to the terminal device of the target user who has logged into the AI server, wherein the first login request includes first user information; a first determining module, configured to determine, based on the first user information, that a user corresponding to the first login request is the target user; and a pushing module, configured to push the link of the first AI model to the terminal device of the target user in the case that the user corresponding to the first login request is the target user.

In some embodiments, the apparatus further includes: a second receiving module, configured to receive a second login request before the link of the first AI model is pushed to the terminal device of the target user who has logged into the AI server, wherein the second login request includes second user information; a second determining module, configured to determine, based on the second user information, whether a user corresponding to the second login request is an administrative user; a first displaying module, configured to display an AI service list including an AI service corresponding to the first AI model in the case that the user corresponding to the second login request is the administrative user; and a pushing module, configured to push the link of the first AI model to the terminal device of the target user in response to receiving a push instruction triggered based on the AI service corresponding to the first AI model in the AI service list.

In some embodiments, the pushing module is configured to send push information to the terminal device of the target user who has logged into the AI server, wherein the push information includes the link of the first AI model.

In some embodiments, the apparatus further includes: a second displaying module, configured to display an AI service page including the updated second AI model; and an updating module, configured to determine a plurality of training samples based on the business data, and train the second AI model based on the plurality of training samples until a stop condition is satisfied.

In some embodiments, the updating module is further configured to preprocess the plurality of training samples.

According to a third aspect of the embodiments of the present disclosure, a device for updating AI models is provided. The device is applicable to an AI server. The AI server includes a model running environment and a model training environment, wherein an AI model deployed in the model running environment is available for a user. The device includes: a processor, a communication interface, a memory, and a communication bus, wherein the processor, the communication interface, and the memory are communicated via the communication bus.

The memory is configured to store a computer program; and

the processor, when loading and running the computer program, is caused to perform the method as described above.

According to a fourth aspect of the embodiments of the present disclosure, a computer-readable storage medium is provided. The storage medium stores a computer program. The computer program, when loaded and run by a processor of an electronic device, causes the electronic device to perform the method as described above.

According to a fifth aspect of the embodiments of the present disclosure, a computer program product is provided. The computer program product includes a program or code. The program or code, when loaded and run by a processor of an electronic device, causes the electronic device to perform the method as described above.

### BRIEF DESCRIPTION OF THE DRAWINGS

FIG. 1 is a flowchart of a method for updating AI models according to an embodiment of the present disclosure;

FIG. 2 is a flowchart of a method for updating a second AI model based on business data according to an embodiment of the present disclosure;

FIG. 3 is a flowchart of another method for updating AI models according to an embodiment of the present disclosure;

FIG. 4 is a flowchart of yet another method for updating AI models according to an embodiment of the present disclosure;

FIG. 5 is a flowchart of a method for determining whether a user corresponding to a first login request is a target user according to an embodiment of the present disclosure;

FIG. 6 is a flowchart of a method for displaying an AI service list according to an embodiment of the present disclosure;

FIG. 7 is a schematic diagram of a user of an AI server according to an embodiment of the present disclosure;

FIG. 8 is a schematic diagram of a user interface according to an embodiment of the present disclosure;

FIG. 9 is a schematic diagram of another user interface according to an embodiment of the present disclosure;

FIG. 10 is a schematic diagram of yet another user interface according to an embodiment of the present disclosure;

FIG. 11 is a schematic diagram of an AI service page according to an embodiment of the present disclosure;

FIG. 12 is a schematic structural diagram of an apparatus for updating AI models according to an embodiment of the present disclosure;

FIG. 13 is a schematic structural diagram of a device for updating AI models according to an embodiment of the present disclosure.

### DETAILED DESCRIPTION

The embodiments of the present disclosure are described with reference to the accompanying drawings. The embodiments described below are only part of the embodiments of the present disclosure. Based on the embodiments of the present disclosure, all other embodiments obtained by those of ordinary skill in the art without creative work, shall fall within the protection scope of the present disclosure.

An AI server usually generates sample data based on the raw data, trains an AI model based on the sample data, and publishes a trained AI model online for users to use. In general, the raw data is related to the AI model to be trained. However, the raw data is not certainly the business data of the application scenario of the AI model to be trained, which makes it difficult for the trained AI model to match the application scenario. As a result, after the trained AI model is deployed, the accuracy of processing results of the AI model on the business data of its application scenario are low.

For example, for an AI model configured to conduct personnel mobility analysis by video surveillance, the application scenario of the AI model is a subway station to be opened. However, the raw data used to train the AI model may be the surveillance videos of other opened subway stations. Since the installation positions and installation angles of surveillance cameras in different subway stations are usually different, and people flow conditions of the different subway stations are also different, it is impossible to accurately analyze personnel mobility, and the accuracy of processing results is low in the case that the AI model, trained by using the surveillance videos of other opened subway stations as raw data, is applicable to the to-be-opened subway station.

The present disclosure provides a method and device for updating AI models, and a storage medium. The AI server includes a model running environment and a model training environment. An AI model deployed in the model running environment can be available for a user. For a same AI model, the AI model is deployed in a model running environment and a model training environment respectively. Business data, generated by a user in a process of using the AI model deployed in a model running environment, is acquired, and the AI model deployed in the model training environment is updated based on the business data. Since the business data used to update the AI model is generated in the process of using the AI model, the updated AI model can match the application scenario of the AI model, which can improve the accuracy of processing results of the AI model.

The method for updating AI models according to the embodiments of the present disclosure is firstly introduced.

The method for updating AI models according to the embodiments of the present disclosure is applicable to an AI server. The AI server may be a server or a cluster composed of a plurality of servers. The AI server may provide an AI service platform, which may be a network platform that provides a user with AI model training and AI model publishment. The AI service platform may provide a user with a variety of AI services, and each AI service is corresponding to an AI model. For example, the AI service platform can provide a user with a face recognition service, a vehicle violation recognition service, a passenger flow measurement service, and the like. Each of the face recognition service, the vehicle violation recognition service, and the passenger flow measurement service may be corresponding to an AI model.

In the embodiments of present disclosure, the AI server includes a model running environment and a model training environment. The model training environment is configured to train an AI model. An AI model deployed in the model running environment can be available for a user. If an AI model is deployed in the model running environment of the AI server, it can be considered that the AI model is published to the AI service platform. That is, the AI model that has been published on the AI service platform is deployed in the model running environment of the AI server.

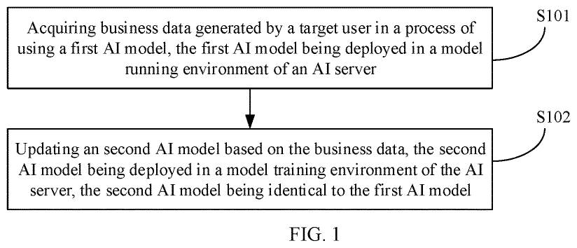

Referring to FIG. 1, FIG. 1 shows a flowchart of a method for updating AI models according to an embodiment of the present disclosure. The method includes processes S101 and S102.

In S101, business data generated by a target user in a process of using a first AI model is acquired, wherein the first AI model is deployed in a model running environment of the AI server.

In S102, a second AI model is updated based on the business data, wherein the second AI model is deployed in a model training environment of the AI server, and the second AI model is identical to the first AI model.

The first AI model and the second AI model are the same AI model deployed in different environments. The first AI model and the second AI model may both be deep learning models, such as a convolutional neural network model, a deep belief network model, or a stack adaptive network model, or the like, or may be other machine learning models other than deep learning models, which is not limited in the embodiments of the present disclosure.

In summary, in the method for updating AI models according to the embodiments of the present disclosure, the first AI model deployed in the model running environment can be available for the target user, the second AI model being deployed in the model training environment is identical to the first AI model deployed in the model running environment. The AI server may acquire the business data generated by the target user in the process of using the first AI model, and update the second AI model deployed in the model training environment based on the business data. The business data generated by the target user in the process of using the first AI model is the actual data of the application scenario of the first AI model, so that an updated second AI model, obtained by the AI server updating the second AI model based on the business data, can match the application scenario of the first AI model (i. e., the second AI model). Therefore, the updated second AI model can output accurate processing results. That is, the method for updating AI models according to the embodiments of the present disclosure can improve the accuracy of processing results of the updated AI model.

In embodiments of the present disclosure, the AI model deployed in the AI server includes a mature AI model and an immature AI model. The mature AI model refers to an AI model that the training of the AI model has been completed. The functions of the mature AI model are mature, and mature AI model usually does not have a function to be updated. The mature AI model can provide accurate processing results. The mature AI model is visible to all users logged into the AI server. That is, the mature AI model can be available for all users logged into the AI server. The mature AI model is generally deployed in the model running environment of the AI server. The immature AI model refers to an AI model that the training of the AI model has not been completed yet. The immature AI model has a function to be updated. The accuracy of processing results of the immature AI model is generally low. The immature AI model may be visible to part of users logged into the AI server (for example, a trial user, an administrative user). That is, the immature AI model can be available for part of users logged into the AI server. In some embodiments, the immature AI model may also be visible to all users logged into the AI server, which is not limited in the embodiments of the present disclosure. The immature AI model may become a mature AI model by training. The immature AI model may be deployed in the model running environment of the AI server, or in the model training environment of the AI server.

In embodiments of the present disclosure, both the first AI model and the second AI model are mature AI models, the first AI model is identical to the second AI model, and the second AI model needs to be updated. In some embodiments, the first AI model and the second AI model are AI models that have been trained but do not reach an ideal state. The target user may be a trial user logged into the AI server, and the target user may be the user in the application scenario of the second AI model. The first AI model deployed in the model running environment may be available for the target user. Business data may be generated by the target user in the process of using the first AI model. The AI server may acquire the business data, and update the second AI model based on the business data. The business data generated by the target user in the process of using the first AI model may be the business data in the application scenario of the second AI model, so that the updated second AI model based on the business data can match the application scenario of the second AI model. Therefore, the updated second AI model has a higher accuracy of processing results of the business data of the application scenario of the second AI model, contributing to improving user experience.

In an optional embodiment, the target user uses the first AI model by the terminal device. The terminal device of the target user may collect the business data generated by the target user in the process of using the first AI model, and send the business data to the AI server. Therefore, in S101, the AI server may receive the business data from the terminal device of the target user. The business data, generated by the target user in the process of using the first AI model, is the business data of the application scenario of the second AI model (i. e., the first AI model). For example, the application scenario of the second AI model is a subway station A, the business data may be images or videos taken by surveillance device installed at the entrance of the subway station A.

In some embodiments, in S102, the AI server determines a plurality of training samples based on the acquired business data, and trains the second AI model based on the plurality of training samples until the second AI model converges. In the case that the second AI model converges, the AI server determines that a stop condition has been satisfied, and determines the trained second AI model as the updated second AI model in the case that the stop condition has been satisfied. The updated second AI model is a mature AI model that can provide accurate processing results.

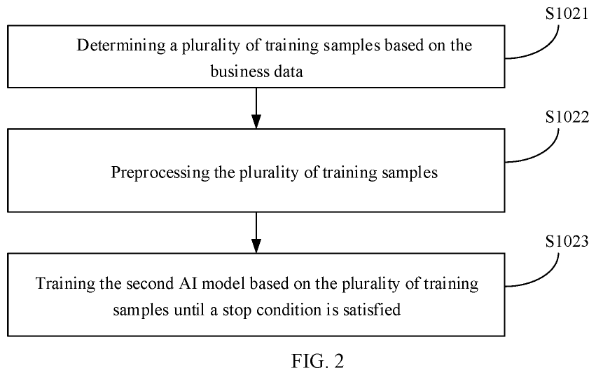

The AI server may preprocess the plurality of training samples prior to training the second AI model based on the plurality of training samples. For example, the AI server labels the plurality of training samples to obtain a tag of each training sample of the plurality of training samples. In some embodiments, referring to FIG. 2, it shows a flowchart of a method for updating AI models based on business data according to embodiments of the present disclosure. As shown in FIG. 2, the method includes processes S1021 to S1023.

In S1021, a plurality of training samples are determined based on the business data.

In some embodiments, the plurality of training samples are generated by the AI server based on the business data.

For example, the business data is a surveillance video including multiple frames of surveillance images. The AI server can use each frame of surveillance image in the surveillance video as the training sample.

In S1022, the plurality of training samples are preprocessed.

The preprocessing may include labeling. The AI server may label each training sample of the plurality of training samples, such that each training sample has a tag. Alternatively, each training sample of the multiple training samples may be manually labeled, and the AI server acquires the tag that manually labeled for each training sample.

In some embodiments, the training sample is a surveillance image, and the preprocessing includes resolution processing (for example, pixel interpolation). The AI server may perform pixel interpolation on each training sample of the plurality of training samples, such that the number of pixels of the training sample is increased, thereby increasing the resolution of the training sample.

In S1023, the second AI model is trained based on the plurality of training samples until a stop condition is satisfied.

The training samples described in S1023 are the training samples preprocessed by S2012.

The AI server may train the second AI model based on the preprocessed plurality of training samples until the stop condition is satisfied. The AI server determines the second AI model obtained in the case that the stop condition is satisfied, as the updated second AI model. The AI server may use any training method in the model training field to train the second AI model, such as a gradient descent algorithm, a stochastic gradient descent algorithm, or the like.

The stop condition may include the second AI model converging, a number of training times of the second AI model reaching a specified number of times, the accuracy of the second AI model reaching a preset accuracy, a number of iteration times of the training sample reaching a preset number of times, or other stop conditions. The specified number of times, the preset number of times, and the preset accuracy are determined according to accuracy requirements of the second AI model, for example, the specified number of times is 8000, 10000, 15000, or the like, the preset number of times is 8000, 10000, 15000, or the like, and the preset accuracy is 90%, 95%, 98%, or the like, which are not limited in the embodiments of the present disclosure.

In some embodiments, for each preprocessed training sample, the AI server inputs the training sample into the second AI model, and hence the second AI model carries out computation based on the training sample, and outputs a computation result (or referred to as a processing result). The AI server adjusts model parameters of the second AI model based on the computation result output by the second AI model. In response to adjusting the model parameters, the AI server inputs the training sample into the adjusted second AI model, causing the adjusted second AI model to compute based on the training samples, and output a computation result. The AI server continues to adjust the model parameters of the second AI model based on the computation result output by the second AI model, and repeats above processes until the stop condition is satisfied.

As one example, for each preprocessed training sample, in response to acquiring the computation result output by the second AI model (including a second AI model upon adjusting the parameter) based on the training sample, the AI server acquires a discrepancy between the computation result and the tag of the training sample, and adjusts the model parameter of the second AI model based on the discrepancy between the computation result and the tag of the training sample. For example, both the computation result and the tag of the training sample are numerical values. The discrepancy between the computation result and the tag of the training sample is the difference value between the computation result and the annotation of the training sample. In response to acquiring the difference value between the computation result and the tag of the training sample in the case that the difference value is greater than a preset difference value, the AI server adjusts the model parameters of the second AI model according to the difference value.

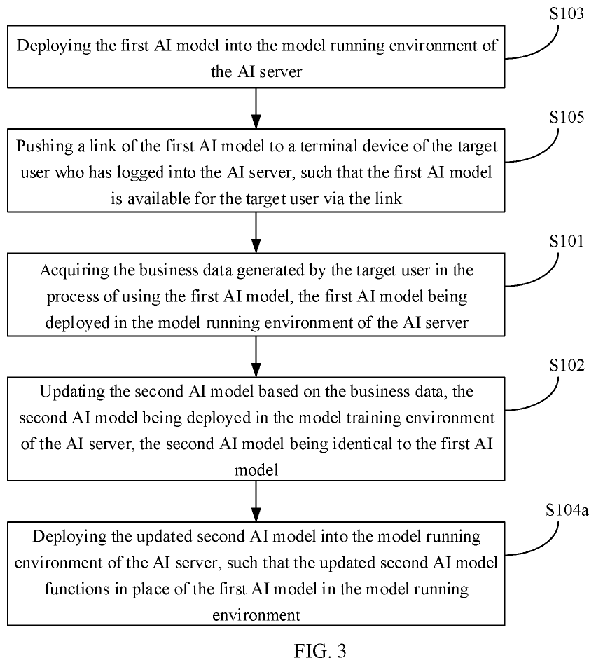

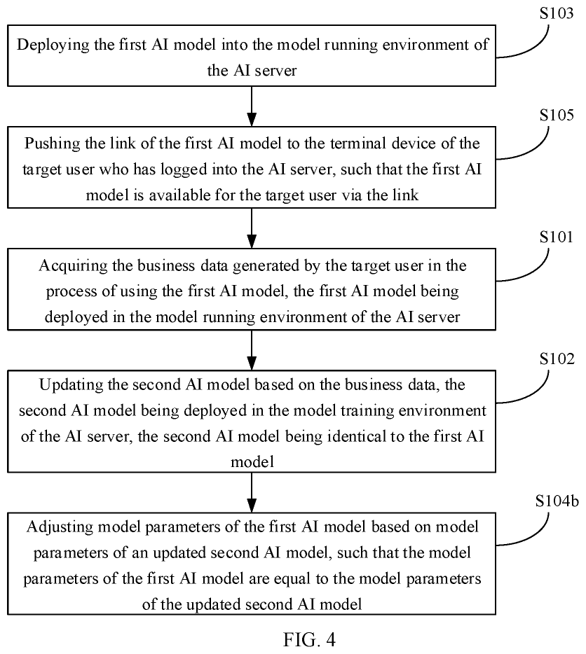

In some embodiments, referring to FIGS. 3 and 4, FIGS. 3 and 4 show flowcharts of other two methods for updating AI models according to the embodiments of the present disclosure. Prior to S101, the method further includes the following process S103.

In S103, the first AI model is deployed into the model running environment of the AI server.

In some embodiments, the AI model published on the AI service platform is generally deployed in the model running environment of the AI server. The AI server may publish the first AI model on the AI service platform, so as to deploy the first AI model into the model running environment of the AI server.

In some embodiments, with reference to FIG. 3, upon S102, the method further includes process S104a.

In S104a, the updated second AI model is deployed into the model running environment of the AI server, such that the updated second AI model functions in place of the first AI model in the model running environment.

In some embodiments, the AI server publishes the updated second AI model on the AI service platform, so as to deploy the updated second AI model into the model running environment of the AI server. Prior to or upon publishing the updated second AI model on the AI service platform, the AI server may delete the first AI model deployed in the model running environment, so as to function in place of the first AI model by the updated second AI model. In this case, the updated second AI model is a mature AI model that can provide accurate processing results.

In some embodiments, with reference to FIG. 4, upon S102, the method further includes process S104b.

In S104b, the model parameters of the first AI model are adjusted based on the model parameters of the updated second AI model, such that the model parameters of the first AI model are equal to the model parameters of the updated second AI model.

In this case, the updated second AI model is a mature AI model that can provide accurate processing results. The AI server can acquire the model parameters of the updated second AI model, and adjust the model parameters of the first AI model deployed in the model running environment based on the model parameters of the updated AI model, such that the model parameters of the first AI model are equal to the model parameters of the updated second AI model. The first AI model can be a mature AI model that can provide the same accurate processing results as the updated second AI model, by adjusting the model parameters of the first AI model to be equal to the model parameters of the updated second AI model.

In embodiments of the present disclosure, the first AI model and the second AI model are the same AI model, the first AI model and the second AI model include at least one model parameter, and a number of model parameters of the first AI model is equal to a number of model parameters of the second AI model. The AI server may adjust a corresponding model parameter of the first AI model based on each model parameter of the updated second AI model such that the parameters in the two AI models are equal. With such adjustment, each model parameter of the adjusted first AI model is finally equal to the corresponding model parameter of the updated second AI model.

In some embodiments, with reference to FIGS. 3 and 4, prior to S101, the method may further include process S105, which may be performed upon S103.

In S105, a link of the first AI model is pushed to a terminal device of the target user who has logged into the AI server, such that the first AI model is available for the target user via the link.

After the target user has logged into the AI server, the AI server may push the link of the first AI model to the terminal device of the target user, such that the first AI model is available for the target user via the link. For example, after the AI server pushes the link of the first AI model to the terminal device of the target user, the terminal device of the target user displays the link of the first AI model, and the target user can click on the link of the first AI model displayed by the terminal device to access the first AI model, thereby using the first AI model. The display form of the link of the first AI model may be a button, a text, an icon, or the like, such that the target user may trigger the link of the first AI model by clicking, or the like, to access the first AI model.

In some embodiments, the AI server sends push information to the terminal device of the target user, the push information including the link of the first AI model, in this way, the AI server may push the link of the first AI model to the terminal device of the target user. The link of the first AI model may be a uniform resource locator (URL) address of the first AI model, or other forms of address that can be linked to the first AI model. The push information may be short messages, mails, instant messages, and the like.

The target user is a trial user in the application scenario of the first AI model. That is, the target user is the user in the application scenario, of a mature first AI model or a mature second AI model. For example, the application scenario of the first AI model is detection of entrance personnel of subway station A, and the target user may be staff of the subway station A. For another example, the application scenario of the first AI model is vehicle recognition of intersection B, and the target user may be a manager of the transportation department to which the intersection B belongs. The AI server may pre-record a user identification of the trial user in the application scenario of the first AI model, so as to determine whether the user who has logged into the AI server is the trial user in the application scenario of the first AI model (i.e., the target user), thereby pushing the link of the first AI model to the terminal device of the target user. The user identification may be information that can uniquely identify the identity of the user, such as a username, a user ID (identifier), or the like, which is not limited in the embodiments of the present disclosure.

In some embodiments, prior to S105, the AI server may receive a first login request and determine whether a user corresponding to the first login request is the target user, and in the case that the user corresponding to the first login request is the target user, the AI server performs S105.

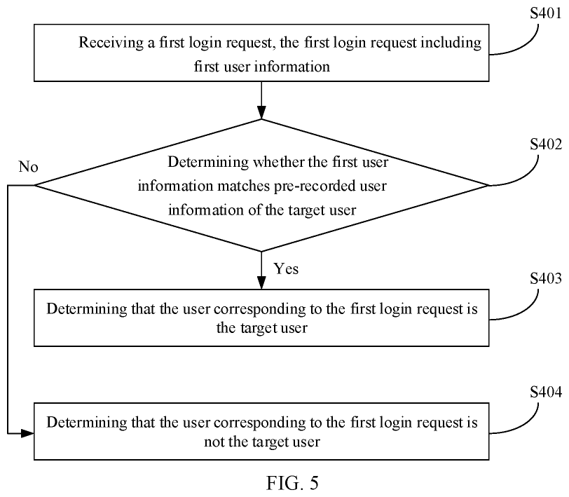

Referring to FIG. 5, a flowchart of a method for determining whether a user corresponding to the first login request is the target user according to an embodiment of the present disclosure is given. As shown in FIG. 5, the method includes processes S401 to S404.

In S401, a first login request is received, wherein the first login request includes a first user information.

The user (for example, the target user) may trigger the terminal device to send the first login request to the AI server, and the AI server may receive the first login request from the terminal device. For example, the user operates the terminal device to trigger the terminal device to send the first login request to the AI server in response to logging into the AI server. The first login request includes the first user information, and the first user information may include information indicative of the identity of the user, such as a username, a user ID, or the like.

In S402, whether the first user information matches pre-recorded user information of the target user is determined. In the case that the first user information matches the pre-recorded user information of the target user, S403 is performed. In the case that the first user information does not match the pre-recorded user information of the target user, S404 is performed.

The target user may be a trial user. The AI server records at least one user information of the trial user. Upon receiving the first login request, the AI server acquires the first user information from the first login request, and compares the first user information with the user information of the pre-recorded trial user to determine whether the first user information matches the pre-recorded user information of the trial user. In the case that the first user information matches the pre-recorded user information of the trial user, it is indicated that the user corresponding to the first login request is the target user (i. e., the trial user), and the AI server performs S403. In the case that the first user information does not match the pre-recorded user information of the trial user, it is indicated that the user corresponding to the first login request is not the target user, and the AI server performs S404.

As described above, the first AI model (i. e., the second AI model) is an immature AI model. In one embodiment, a plurality of immature AI models are deployed in the AI server. In order to facilitate the determination of the trial users corresponding to each immature AI model, the AI server may store a corresponding relationship between the immature AI model and user information, and each user information in the corresponding relationship is the information of the trial user of the corresponding immature AI model. For example, the corresponding relationship is as shown in Table 1 below:

TABLE 1

| User information | Immature AT model |
|---|---|
| User information U1 | AI model 1 |
| User information U2 | AI model 2 |
| User information U3 | AI model 3 |
| User information U4 | AI model 4 |
| . . . | . . . |
| User information Un | AI model n |

As shown in Table 1, user information U1 to user information Un are in a one-to-one correspondence with AI models 1 to n. It is assumed that the user information U1 is the information of a user 1, since the user information U1 corresponds to the AI model 1, the trial user of the AI model 1 is the user 1. It is assumed that the user information U2 is the information of a user 2, since the user information U2 corresponds to the AI model 2, the trial user of the AI model 2 is the user 2, and so on.

The present disclosure assumes that the first AI model is the AI model 3, and the first user information is the user information U3. The AI server determines that the user corresponding to the first login request is the user of the AI model 3 based on the corresponding relationship between the first user information and Table 1. That is, the AI server determines that the user corresponding to the first login request is the target user.

In S403, the user corresponding to the first login request is determined as the target user.

In S402, in the case that the AI server determines that the first user information matches the pre-recorded user information of the target user, the AI server determines that the user corresponding to the first login request is the target user.

In S404, the user corresponding to the first login request is determined as non-target user.

In S402, in the case that the AI server determines that the first user information does not match the pre-recorded user information of the target user, the AI server determines that the user corresponding to the first login request is not the target user. That is, the user corresponding to the first login request is not the trial user of the first AI model.

According to the description of the embodiment shown in FIG. 5, the AI server may determine whether the user corresponding to the login request is the target user based on the user information included in the login request. In this way, in the case that the user logs into the AI server, the AI server can automatically identify the target user without manual identification, thereby reducing the cost of identifying the target user, and improving the efficiency of identifying the target user.

In some embodiments, before the AI server pushes the link of the first AI model to the terminal device of the target user who has logged into the AI server, the AI server may display an AI service list including an AI service corresponding to the first AI model. The user (for example, the administrative user) may trigger a push instruction of the first AI model based on the AI service corresponding to the first AI model in the AI service list. The AI server pushes the link of the first AI model to the terminal device of the target user in response to receiving the push instruction. The following describes the implementation process of the AI server displaying the AI service list with reference to the accompanying drawings.

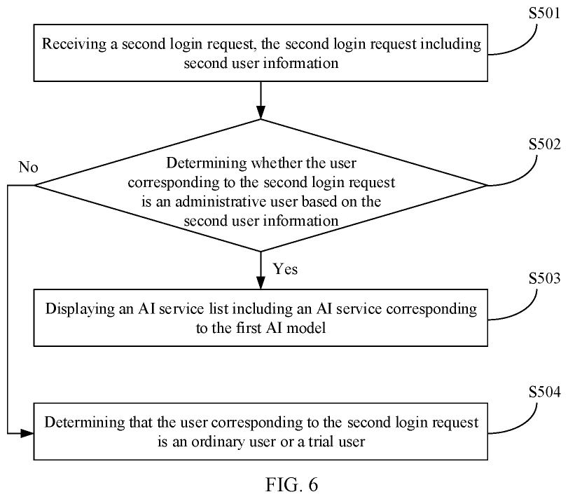

Referring to FIG. 6, a flowchart of a method for displaying an AI service list according to an embodiment of the present disclosure is given. As shown in FIG. 6, the method includes processes S501 to S504.

In S501, a second login request is received, wherein the second login request includes second user information.

The user (for example, the administrative user) may trigger the terminal device to send the second login request to the AI server, and the AI server may receive the second login request from the terminal device. For example, in the case of logging into the AI server, the user operates the terminal device to trigger the terminal device to send a second login request to the AI server. The second login request includes second user information, and the second user information may include information that can identify the identity of the user, such as a username, a user ID, or the like.

In S502, whether the user corresponding to the second login request is the administrative user is determined based on the second user information. In the case that the user corresponding to the second login request is the administrative user, S503 is performed. In the case that the user corresponding to the second login request is not the administrative user, S504 is performed.

The AI server records at least one user information of the administrative user. Upon receiving the second login request, the AI server acquires the second user information from the second login request, and compares the second user information with the pre-recorded user information of the administrative user to determine whether the second user information matches the pre-recorded user information of the administrative user. In the case that the second user information matches the user information of the pre-recorded administrative user, it is indicated that the user corresponding to the second login request is the administrative user, and the AI server performs S503. In the case that the second user information does not match the pre-recorded user information of the administrative user, it is indicated that the user corresponding to the second login request is not the administrative user, and the AI server performs S504.

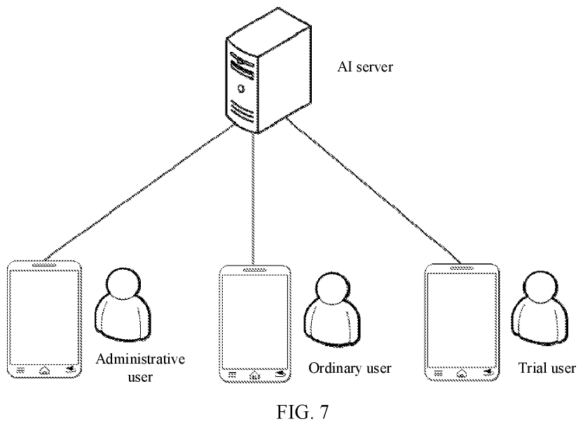

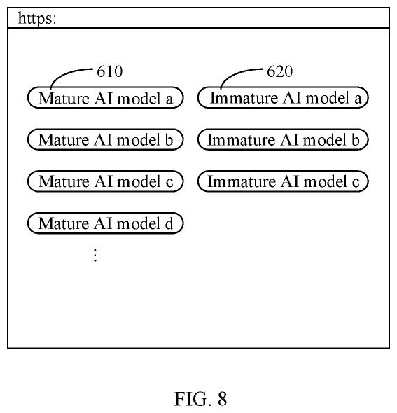

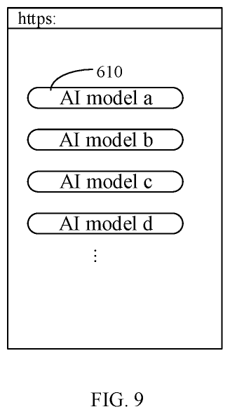

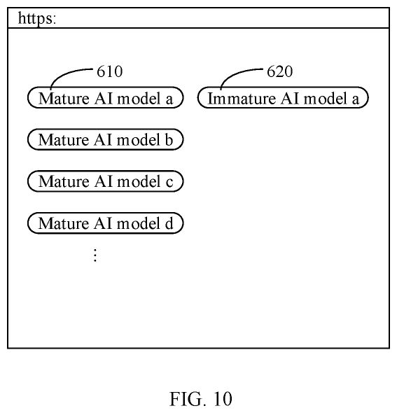

In some embodiments, as shown in FIG. 7, the user may be divided into three types, a trial user, an ordinary user, and an administrative user. The AI server may pre-record a correspondence between the user information and the user type, such that the AI server determines the user type of the user corresponding to the login request, based on the user information included in the login request, in response to receiving the login request. All mature AI models and all immature AI models deployed in the AI server are visible to the administrative user, all mature AI models deployed in the AI server are visible to the ordinary user and the trial user, and any immature AI model deployed in the AI server is visible to the trial user of the immature AI model. For example, a user interface corresponding to the administrative user in the AI server includes links of all mature AI models and links of all immature AI models, a user interface corresponding to the ordinary user includes links of all mature AI models, and a user interface corresponding to the trial user includes links of all mature AI models and links of the immature AI models corresponding to the trial user. Regardless of the user interface corresponding to the administrative user, the ordinary user, or the trial user, the links of each AI model in the user interface may be embodied in the form of buttons, icons, or the like. For example, the user interface corresponding to the administrative user may be as shown in FIG. 8, the user interface corresponding to the ordinary user may be as shown in FIG. 9, and the user interface corresponding to the trial user may be as shown in FIG. 10. Referring to FIG. 8, a button 610 corresponding to each mature AI model of the plurality of mature AI models and a button 620 corresponding to each immature AI model of the plurality of immature AI models are included in the user interface corresponding to the administrative user. Referring to FIG. 9, a button 610 corresponding to each mature AI model of the plurality of mature AI models is included in the user interface corresponding to the ordinary user. Referring to FIG. 10, a button 610 corresponding to each mature AI model of the plurality of mature AI models and a button 620 corresponding to an immature AI model corresponding to the trial user are included in the user interface corresponding to the trial user. It should be noted that, the immature AI model is not visible to the ordinary user. Therefore, the user interface corresponding to an ordinary user may not show whether the AI model is a mature AI model. The AI models presented in the user interface corresponding to the ordinary user are defaulted to be mature AI models, which is not limited in the embodiments of this application.

In S50, an AI service list including an AI service corresponding to the first AI model is displayed.

In S502, in the case that the AI server determines that the user corresponding to the second login request is the administrative user, the AI server displays the AI service list including at least one AI service, where each AI service corresponds to an AI model. An AI service corresponding to the first AI model is included in the AI service list.

The AI service list may include the AI service corresponding to a mature AI model, and may also include the AI service corresponding to an immature AI model. In some embodiments, the AI service list includes a name of the AI service corresponding to each AI model.

In S504, the user corresponding to the second login request is an ordinary user or a trial user is determined.

In S502, in the case that the AI server determines that the user corresponding to the second login request is not the administrative user, the AI server determines that the user corresponding to the second login request is an ordinary user or a trial user. For example, the AI server compares the second user information included in the second login request with the pre-recorded user information of the trial user to determine whether the second user information matches the pre-recorded user information of the trial user. In the case that the second user information matches the pre-recorded user information of the trial user, the AI server determines that the user corresponding to the second login request is a trial user. In the case that the second user information does not match the pre-recorded user information of the trial user, the AI server determines that the user corresponding to the second login request is an ordinary user.

In some embodiments, in the case that the user corresponding to the second login request is a trial user, the AI server can display a trial AI service page, and the trial AI service page may include a link of the immature AI model corresponding to the trial user, facilitating the administrative user to determine the AI model corresponding to the trial user. In the case that the user corresponding to the second login request is an ordinary user, the AI server may display an ordinary AI service page. The ordinary AI service page may include links of various mature AI models, and the ordinary AI service page usually does not include links of immature AI models. In this way, ordinary users are prevented from using immature AI models, thereby avoiding impacts caused to user experience and enterprises image.

In some embodiments, upon S503, the administrative user may trigger a push instruction based on the AI service corresponding to the first AI model in the AI service list. The AI server pushes the link of the first AI model to the terminal device of the target user in response to receiving the push instruction. In some embodiments, each AI service in the AI service list corresponds to a trigger interface, for example, a trigger button or the like. The administrative user may trigger a push instruction of the first AI model via a trigger interface corresponding to the first AI service (the AI service corresponding to the first AI model). For example, the first AI model is the AI model 3 in Table 1 in the case that the AI server receives a push instruction of the AI service corresponding to the AI model 3 and pushes the link of the AI model 3 to the terminal device of the target user.

In the technical solutions according to the embodiments of the present disclosure, prior to pushing the link of the first AI model to the terminal device of the target user, the AI server may receive the second login request, and determine, based on the second user information included in the second login request, whether the user corresponding to the second login request is an administrative user. In the case that the user corresponding to the second login request is an administrative user, the AI server displays the AI service list including the AI service corresponding to the first AI model. Upon receiving the push instruction triggered based on the AI service corresponding to the first AI model in the AI service list, the AI server pushes the link of the first AI model to the terminal device of the target user. In this way, compared with the current AI server, there is no need to configure a different AI service page for each user, and there is no need to make greater improvements to the configuration of the AI server, hence the configuration cost of the AI server is lower.

In some embodiments, upon completion of updating the second AI model, the AI server mark the updated second AI model as a mature AI model. For example, the AI server removes the second AI model from the immature AI models, and adds the updated second AI model to the mature AI models, so as to mark the updated second AI model as a mature AI model. In this way, the updated second AI model may be available for a user, the user including an ordinary user, a trial user, and an administrative user.

In some embodiments, the AI server records the mature AI models and the immature AI models in the form of an AI service list. For example, the AI server may maintain a mature AI service list for recording a link of a mature AI model, and an immature AI service list for recording a link of an immature AI model. The link of the second AI model is recorded in the immature AI service list before the AI server updates the second AI model. Upon completion of updating the second AI model update, the AI server adds the link of the updated second AI model to the mature AI service list, deleting the link of the second AI model in the immature AI service list. Before the AI server adjusts the model parameters of the first AI model based on the model parameters of the updated AI model, the link of the first AI model is recorded in the immature AI service list. In response to adjusting the model parameters of the first AI model to be equal to the model parameters of the updated second AI model, the AI server adds the link of the first AI model to the mature AI service list, and deletes the link of the first AI model in the immature AI service list. Taking the case where both the link of the first AI model and the link of the second AI model are URL as an example for illustration, upon completion of updating the second AI model, the AI server first generates a URL for the updated second AI model based on a URL generation rule of the mature AI model, and then adds the URL of the updated second AI model to the mature AI service list. For example, the URL generated for the updated second AI model is https://AI0003.com. Alternatively, in response to adjusting the model parameters of the first AI model to be equal to the model parameters of the updated second AI model, the AI server modifies the URL of the first AI model based on the URL generation rule of the mature AI model, and then adds the modified URL of the first AI model to the mature AI service list. For example, the modified URL of the first AI model is https://AI0003.com.

Upon updating the second AI model, the AI server may display an AI service page including the updated second AI model. For example, in the case that a user, including an ordinary user, a trial user, and an administrative user, logs into the AI server, the AI server displays the AI service page including the updated second AI model, thus facilitating the user to view and use the updated second AI model. In some embodiments, in response to adding the link of the updated second AI model to the mature AI service list, or in response to adjusting the model parameters of the first AI model to be equal to the model parameters of the updated second AI model, the AI server sends the mature AI service list to the terminal device of the user in the case that the user logs into the AI server. In response to receiving the mature AI service list, the terminal device of the user displays the AI service page including the mature AI service list. In the AI service page, the links of the AI models in the mature AI service list may be shown in the form of buttons, texts, icons, and the like. The AI service page may also provide an AI service search function, for example, the AI service page includes an AI service search box, a search button, and the like, so as to achieve the AI service search function.

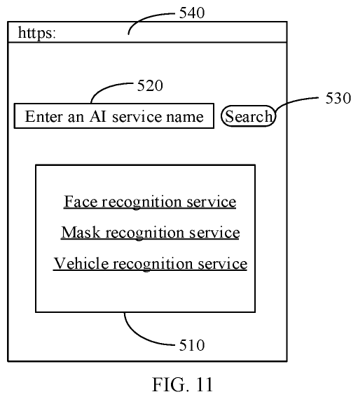

Referring to FIG. 11, a schematic diagram of an AI service page according to some embodiments of the present disclosure is given. The AI service page includes a mature service list 510, an AI service search box 520, and a search button 530, and an address bar 540. The mature service list 510 includes names of a plurality of AI services. The plurality of AI services are respectively face recognition service, mask recognition service, and vehicle recognition service. The AI model corresponding to the face recognition service is a face recognition model, and a URL of the face recognition model may be https://AI0001.com. The AI model corresponding to the mask recognition service is a mask recognition model, and a URL of the mask recognition model may be https://AI0002.com. The AI model corresponding to the vehicle recognition service is a vehicle recognition model, and a URL of the vehicle recognition model may be https://AI0004.com. The user may trigger the terminal device to display the corresponding AI model page by clicking the name of an AI service, or the user may enter an AI service name in the AI service search box 520 and click the search button 530 to trigger the terminal device to display the corresponding AI model page. In the case that the terminal device displays the AI service page, the URL of the AI service page may be displayed in the address bar 540 on the AI service page.

In the embodiments of the present disclosure, the URL generation rule of the immature AI model is different from the URL generation rule of the mature AI model. In this way, ordinary users are prevented from inferring the URL of the immature AI model based on the URL of the mature AI model, thereby avoiding an unsatisfactory user experience caused by the ordinary user using the immature AI model. In some embodiments, the URL of the immature AI model and the URL of the mature AI model have different rules. For example, a URL of an immature AI model is generated by using a rule of a name (for example, a name of an AI service)+sequence number, and a URL of a mature AI model is generated by using a rule of randomly generating a long garbled code composed of special characters. Alternatively, the URL of the immature AI model is composed of a character string of higher complexity, and the URL of the mature AI model is composed of a character string of lower complexity, which are not limited in the embodiment of the present disclosure.

For example, in the case that the URL generation rule of the immature AI model is identical to the URL generation rule of the mature AI model, it is assumed that the URL of an immature AI model is https://AI0003.com, the ordinary user views https://AI0001.com (the URL of a mature face recognition model), https://AI0002.com (the URL of a mature mask recognition model), and https://AI0004.com (the URL of the mature mouth vehicle recognition model), and the ordinary user can easily infer the URL of https://AI0003.com's. That is, in the case that the URL generation rule of the immature AI model is identical to the URL generation rule of the mature AI model, the ordinary user can easily infer the URL of the immature AI model based on the URL of the mature AI model. Therefore, the URL generation rule of the immature AI models is different from the URL generation rule of the mature AI models in the embodiments of the present disclosure.

The above is an introduction to the method embodiments of the present disclosure. An embodiment of the present disclosure provides a device for updating AI models corresponding to the method for updating AI models described above. The device for updating AI models according to the embodiments of the present disclosure is described below.

The device for updating AI models according to the embodiments of the present disclosure is applicable to an AI server. For example, the device for updating AI models is the AI server, or the device for updating AI models is a partial function component in the AI server. The AI server includes a model running environment and a model training environment, and an AI model deployed in the model running environment can be available for a user.

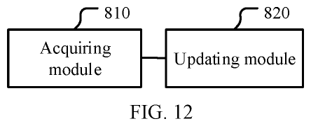

As an example, referring to FIG. 12, FIG. 12 shows a structural diagram of an apparatus for updating AI models according to embodiments of the present disclosure. As shown in FIG. 12, the apparatus includes:

an acquiring module 810, configured to acquire business data generated by a target user in a process of using a first AI model, wherein the first AI model is deployed in the model running environment; and

an updating module 820, configured to acquire to update a second AI model based on the business data, wherein the second AI model is deployed in the model training environment, and the second AI model is identical to the first AI model.

In summary, in the apparatus for updating AI models according to the embodiments of the present disclosure, the first AI model deployed in the model running environment can be available for the target user, and the second AI model deployed in the model training environment is identical to the first AI model deployed in the model running environment. The AI server may acquire the business data generated by the target user in the process of using the first AI model, and update the second AI model based on the business data. The business data generated by the target user in the process of using the first AI model, is the actual data of the application scenario of the first AI model, therefore, the updated second AI model, obtained by the AI server updating the second AI model based on the business data, can match the application scenario of the first AI model, so that the updated second AI model can output accurate processing results. That is, the technical solutions according to the embodiments of the present disclosure can improve the accuracy of processing results of the updated AI model.

In some embodiments, the apparatus further includes a first deploying module, configured to deploy the first AI model into the model running environment before the business data generated by the target user in the process of using the first AI model is acquired.

In some embodiments, the apparatus further includes a second deploying module, configured to deploy an updated second AI model into the model running environment after the second AI model is updated based on the business data, such that the updated second AI model functions in place of the first AI model in the model running environment.

In some embodiments, the apparatus further includes an adjusting module, configured to adjust model parameters of the first AI model based on model parameters of the updated second AI model.

In some embodiments, the apparatus further includes a pushing module, configured to push a link of the first AI model to a terminal device of the target user who has logged into the AI server before the business data generated by the target user in the process of using the first AI model is acquired, such that the first AI model is available for the target user via the link.

In some embodiments, the apparatus further includes:

a first receiving module, configured to receive a first login request before the link of the first AI model is pushed to the terminal device of the target user who has logged into the AI server, wherein the first login request includes first user information; and

a first determining module, configured to determine that the user corresponding to the first login request is the target user based on the first user information;

wherein the pushing module is configured to push the link of the first AI model to the terminal device of the target user in the case that the user corresponding to the first login request is the target user.

In some embodiments, the apparatus further includes:

a second receiving module, configured to receive a second login request before the link of the first AI model is pushed to the terminal device of the target user who has logged into the AI server, wherein the second login request includes second user information;

a second determining module, configured to determine, based on the second user information, whether the user corresponding to the second login request is an administrative user; and

a first displaying module, configured to display an AI service list including an AI service corresponding to the first AI model in the case that the user corresponding to the second login request is an administrative user;

wherein the pushing module is configured to push the link of the first AI model to the terminal device of the target user in response to receiving a push instruction triggered based on an AI service corresponding to the first AI model in the AI service list.

In some embodiments, the pushing module is configured to send push information to the terminal device of the target user who has logged into the AI server, wherein the push information includes the link of the first AI model.

In some embodiments, the device further includes a second displaying module, configured to display an AI service page after the second AI model is updated based on the business data, wherein the AI service page includes the updated second AI model.

In some embodiments, the updating module 820 is configured to generate a plurality of training samples based on the business data, and train the second AI model based on the plurality of training samples until a stop condition is satisfied.

In some embodiments, the updating module 820 is further configured to preprocess the plurality of training samples.

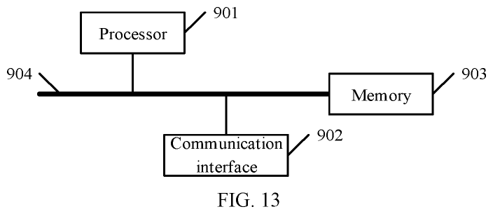

In some embodiments, referring to FIG. 13, a structural diagram of a device for updating AI models according to the embodiments of the present disclosure is given. The device includes a processor 901, a communication interface 902, a memory 903, and a communication bus 904. The processor 901, the communication interface 902, and the memory 903 are communicated via the communication bus 904.

The memory 903 is configured to store a computer program.

The processor 901, when loading and running the computer program, is caused to execute an instruction for performing all or part of the processes in the method for updating AI models described above.

The communication bus 904 may be a peripheral component interconnect (PCI) bus or an extended industry standard architecture (EISA) bus. The communication bus 904 may include an address bus, a data bus, a control bus, and the like. For facilitating representation, the communication bus 904 is shown in a form of a thick line in the figure, which does not mean that there is only one bus, or only one type of bus.

The communication interface 902 may include interfaces for implementing interconnect of internal devices of the device for updating AI models, such as input/output (I/O) interface, physical interfaces, logical interfaces and the like, and interfaces for realizing a communication between the device for updating AI models and other devices. The physical interface may be a gigabit Ethernet (GE) interface, which may be used to the interconnection between the device for updating AI models and other devices. The logical interface is an interface inside the device for updating AI models, which can be used for interconnection of internal devices of the device for updating AI models.

The memory 903 may be various types of storage media. The memory 903 includes a volatile memory and a non-volatile memory (NVM). For example, the memory 903 includes a random-access memory (RAM), a read-only memory (ROM), a non-volatile RAM (NVRAM), a programmable read-only memory (PROM), an erasable programmable read-only memory (EPROM), an electrically erasable programmable read-only memory (EEPROM), a magnetic disk storage, and the like.

The processor 901 may be a general-purpose processor, which performs specific processes and/or operations by reading and executing a computer program stored in the memory (e.g., the memory 903). In a process of performing specific processes and/or operations described above, the general-purpose processor may use the data stored in the memory (e.g., the memory 903). The general-purpose processor may be a central processing unit (CPU), a network processor (NP), or the like. The processor 901 may also be a specific-purpose processor, which is specially designed to perform specific processes and/or operations. The specified-purpose processor may be a digital signal processor (DSP), an application specific integrated circuit (ASIC), a field-programmable gate array (FPGA) or other programmable logic devices, discrete gate or transistor logic devices and discrete hardware components. In addition, the processor 901 may be a combination of multiple processors, such as a multi-core processor. The processor 901 may include at least one circuit, so as to perform all or part of the processes of the method for updating AI models according to the embodiments described above.

The device for updating AI models shown in FIG. 13 is only exemplary. In the implementation process, the device for updating AI models may also include other components, which is not to be listed herein.

An embodiment of the present disclosure provides a computer-readable storage medium storing a computer program. The computer program, when loaded and run by a processor of an electronic device, causes the electronic device to perform all or part of the processes of the method for updating AI models according to the above method embodiments.

An embodiment of the present disclosure provides a computer program product including a program or code. The program or code, when loaded and run by a processor of an electronic device, causes the electronic device to perform all or part of the processes of the method for updating AI models according to the above method embodiments.

In the embodiments described above, the processes of the method for updating AI models may be performed entirely or partly by software, hardware, firmware, or any combinations thereof. When performed by software, the processes may be performed entirely or partly in the form of a computer program product. The computer program product includes one or more computer instructions. When the computer program instructions are loaded and executed by a computer, the processes or functions described in the present disclosure t are entirely or partly generated. The computer may be a general-purpose computer, a specific-purpose computer, a computer network, or other programmable devices. The computer instructions may be stored in a computer-readable storage medium, or be transmitted from one computer-readable storage medium to another computer-readable storage medium, for example, the computer instructions may be transmitted from one website, computer, server, or data center to another website, computer, server, or data center in a wired way (for example, coaxial cable, fiber optic, digital subscriber line (DSL)), or a wireless way (for example, infrared ray, radio, microwave, or the like). The computer-readable storage medium can be any available media that can be accessed by a computer, or a data storage device, such as a server integrated with one or more available media, a data center, or the like. The available medium may be a magnetic medium, (for example, a floppy disk, a hard disk, a magnetic tape), an optical medium (for example, a DVD), or a semiconductor medium (for example, a solid state drive (SSD)), or the like.

In this document, relational terms such as “first,” “second,” and the like are only used to distinguish one entity or operation from another entity or operation, without necessarily requiring or implying any actual relationships or orders between such entities or operations. Furthermore, the terms “comprise,” “include,” and any other variation thereof, are intended to represent a non-exclusive inclusion, such that a process, method, article, or device not only includes listed elements, but may include other elements not explicitly listed, or inherent elements of such process, method, article, or device. An element defined by a statement “include one . . . ” does not preclude the existence of additional identical elements in the process, method, article, or device that includes the element, without more limitation.

The various embodiments in this specification are described in a related manner, and the same or similar parts between the various embodiments may be referred to each other. Each embodiment focuses on the differences from other embodiments. In particular, for the embodiments of the device for updating AI models, the computer-readable storage medium, and the computer program product, since they are generally similar to the method embodiments, the descriptions of them are relatively simple, and the relevant parts may refer to the part of the description of the method embodiments.

Described above are only exemplary embodiments of the present disclosure, and are not intended to limit the present disclosure. Any modification, equivalent replacement, improvement, and the like made within the spirit and principle of the present disclosure shall be included in the protection scope of the present disclosure.

What is claimed is:

1. A method for updating AI models, applicable to an AI server, the AI server comprising a model running environment and a model training environment, an AI model deployed in the model running environment being available for a user;
the method comprising:
acquiring business data generated by a target user in a process of using a first AI model, the first AI model being deployed in the model running environment; and
updating a second AI model based on the business data, the second AI model being deployed in the model training environment, and the second AI model being identical to the first AI model.

2. The method according to claim 1, wherein prior to acquiring the business data generated by the target user in the process of using the first AI model, the method further comprises:
deploying the first AI model into the model running environment.

3. The method according to claim 1, wherein upon updating the second AI model based on the business data, the method further comprises:
deploying an updated second AI model into the model running environment, such that the updated second AI model functions in place of the first AI model in the model running environment.

4. The method according to claim 1, wherein upon updating the second AI model based on the business data, the method further comprises:
adjusting model parameters of the first AI model based on model parameters of an updated second AI model.

5. The method according to claim 1, wherein prior to acquiring the business data generated by the target user in the process of using the first AI model, the method further comprises:
pushing a link of the first AI model to a terminal device of the target user who has logged into the AI server, such that the first AI model is available for the target user via the link.

6. The method according to claim 5, wherein prior to pushing the link of the first AI model to the terminal device of the target user who has logged into the AI server, the method further comprises:
receiving a first login request, the first login request comprising first user information;
determining that a user corresponding to the first login request is the target user, based on the first user information; and
pushing the link of the first AI model to the terminal device of the target user who has logged into the AI server, comprising: pushing the link of the first AI model to the terminal device of the target user in the case that the user corresponding to the first login request is the target user.

7. The method according to claim 5, wherein prior to pushing the link of the first AI model to the terminal device of the target user who has logged into the AI server, the method further comprises:
receiving a second login request, the second login request comprising second user information;
determining, based on the second user information, that a user corresponding to the second login request is an administrative user;
displaying an AI service list comprising an AI service corresponding to the first AI model in the case that the user corresponding to the second login request is the administrative user; and
pushing the link of the first AI model to the terminal device of the target user who has logged into the AI server, comprising: pushing the link of the first AI model to the terminal device of the target user in response to receiving a push instruction triggered based on the AI service corresponding to the first AI model in the AI service list.

8. The method according to claim 5, wherein pushing the link of the first AI model to the terminal device of the target user who has logged into the AI server comprises:
sending push information to the terminal device of the target user who has logged into the AI server, wherein the push information comprises the link of the first AI model.

9. The method according to claim 4, further comprising:
displaying an AI service page comprising the updated second AI.

10. The method according to claim 1, wherein updating the second AI model based on the business data comprises:
determining a plurality of training samples based on the business data; and
training the second AI model based on the plurality of training samples until a stop condition is satisfied.

11. The method according to claim 10, wherein prior to training the second AI model based on the plurality of training samples, the method further comprises:
preprocessing the plurality of training samples.

12. A device for updating AI models, applicable to an AI server, the AI server comprising a model running environment and a model training environment, an AI model deployed in the model running environment being available for a user, the device comprising a processor, a communication interface, a memory, and a communication bus, the processor, the communication interface and the memory being communicated via the communication bus; wherein
the memory is configured to store a computer program;
the processor, when loading and running the computer program, is caused to execute instructions for:
acquiring business data generated by a target user in a process of using a first AI model, the first AI model being deployed in the model running environment; and
updating a second AI model based on the business data, the second AI model being deployed in the model training environment, and the second AI model being identical to the first AI model.

13. The device according to claim 12, wherein the processor, when loading and running the computer program, is further caused to execute an instruction for:
deploying the first AI model into the model running environment.

14. The device according to claim 12, wherein the processor, when loading and running the computer program, is further caused to execute an instruction for:
deploying an updated second AI model into the model running environment, such that the updated second AI model functions in place of the first AI model in the model running environment.

15. The device according to claim 12, wherein the processor, when loading and running the computer program, is further caused to execute an instruction for:
adjusting model parameters of the first AI model according to model parameters of an updated second AI model.

16. The device according to claim 12, wherein the processor, when loading and running the computer program, is further caused to execute an instruction for:
pushing a link of the first AI model to a terminal device of the target user who has logged into the AI server, such that the first AI model is available for the target user via the link.

17. The device according to claim 16, wherein the processor, when loading and running the computer program, is further caused to execute instructions for:
receiving a first login request, the first login request comprising first user information;
determining that a user corresponding to the first login request is the target user, based on the first user information; and
pushing the link of the first AI model to the terminal device of the target user who has logged into the AI server in the case that the user corresponding to the first login request is the target user.

18. The device according to claim 16, wherein the processor, when loading and running the computer program, is further caused to execute instructions for:
receiving a second login request, the second login request comprising second user information;
determining, based on the second user information, that a user corresponding to the second login request is an administrative user;
displaying an AI service list comprising an AI service corresponding to the first AI model in the case that the user corresponding to a second login request is the administrative user; and
pushing the link of the first AI model to the terminal device of the target user in response to receiving a push instruction triggered based on the AI service corresponding to the first AI model in the AI service list.

19. The device according to claim 16, wherein the processor, when loading and running the computer program, is further caused to execute an instruction for:
sending push information to the terminal device of the target user who has logged into the AI server, wherein the push information comprises the link of the first AI model.

20. A computer-readable storage medium storing a computer program, wherein the computer program, when loaded and run a processor of an electronic device, causes the electronic device to perform a method for updating AI models;
the method comprising:
acquiring business data generated by a target user in a process of using a first AI model, the first AI model being deployed in a model running environment; and
updating a second AI model based on the business data, the second AI model being deployed in a model training environment, and the second AI model being identical to the first AI model.
